(19) United States
(12) Patent Application Publication
(10) Pub. No.: US 2007/0260829 A1
(43) Pub. Date: Nov. 8, 2007

(54) Method and apparatus for processing a sequential file

(75) Inventor: Matti Hallivouri, Espoo (FI)

Correspondence Address: YOUNG & THOMPSON, 745 SOUTH 23RD STREET, 2ND FLOOR, ARLINGTON, VA, 22202, US

(73) Assignee: TELLABS OY, ESPOO (FI)

(21) Appl. No.: 11/797,265

(22) Filed: May 2, 2007

(30) Foreign Application Priority Data
May 3, 2006 (FI) 20060427

(51) Int. Cl. G06F 13/00

(52) U.S. Cl. 711/154

(57) ABSTRACT

A method and apparatus for processing a sequential file stored in a block-type memory device. It has surprisingly been found out that by storing metadata (106) associated with the sequential file in that memory block of the block-type memory device which contains an ending location (104) of payload data (103), the write operation associated with the update of the sequential file needs in nearly all situations to be directed to only one memory block of the memory device, the memory block being the memory block containing the ending location of the payload data.

### FIELD OF THE INVENTION

The invention relates to a method for processing a sequential file stored in a block-type memory device. The invention also relates to an apparatus for processing a sequential file stored in a block-type memory device.

### BACKGROUND OF THE INVENTION

Sequential files are files that are updated by additions attached at the end of the file. A sequential file is for example a diary or log file, at the end of which there are added notes of events in the chronological order. In file systems, files include metadata that refers to facts associated with the data contained by the file, below called payload data. Metadata can express for example those address spaces in the memory device where the payload data can be found, check sums associated with error detection and/or other error indicators, the time of last update of the file, conditions on which the payload data is allowed to be read and/or changed, as well as the file size and/or other structural information about the file.

It is typical of block-type memory devices that the processing of the data stored therein or the data that should be stored therein is carried out memory block by memory block. In a block-type memory device, a single memory block represents the memory capacity of a given share of the address space in said memory device. Block-type memory devices are for example flash-type microcircuit memories and magnetic discs. Repeated writing of new data in memory blocks wears a block-type memory device. A single memory block in a memory device only endures a limited number of write operations. In other words, a memory block is worn, when the write operations are repeated sufficiently often. In case even one memory block in a memory device is worn out, generally the whole memory device, such as a flash-type microcircuit memory or magnetic disc, must be replaced. In addition, write operations often repeated in connection with for instance flash-type microcircuit memory devices reduce the number of available memory blocks. In a flash-type microcircuit, any byte in a memory block can be written and read irrespective of other bytes of said memory block. When a byte or bit is set, it cannot be changed until the whole memory block is emptied. The emptying of the memory block is a remarkably slower operation than the reading of the data from the memory block. In case a change need be made in data contained in a given memory block, said memory block must first be emptied, whereafter the changed data can be written. The resulting speed problem can be solved so that the changed data is written in another, already emptied memory block, in which case the earlier used memory block only needs to be emptied after the file update. However, repeated emptying and writing operations result in that the number of memory blocks that are being emptied or waiting for emptying at any given moment is large, which cuts down the number of the available memory blocks.

### PRIOR ART

In prior art file control systems, the metadata associated with the sequential file is located in a memory block that is either completely or partly reserved for said metadata. As a result, a write operation must be directed to the memory device in two different memory blocks, when new payload data is added to the sequential file, for example when a new diary entry is added in the diary file:
in the memory block containing the ending location of the earlier written payload data, and
in the memory block containing metadata.

In the present document, the ending location of the payload data means the data that is last added in said payload.

Consequently, the problem with the prior art arrangement is that one sequential file update operation creates a need to perform write operations in two memory blocks. As was already mentioned earlier in this document, the write operations result in the wearing of the memory device and in a reduction of available memory blocks.

### SUMMARY OF THE INVENTION

The invention relates to a method for processing a sequential file stored in a block-type memory device, by which method the limitations and drawbacks associated with the prior art can be eliminated or alleviated. The invention also relates to an apparatus meant for processing a sequential file stored in a block-type memory device, by which apparatus the limitations and drawbacks associated with the prior art can be eliminated or alleviated. The invention also relates to a computer program designed for processing a sequential file stored in a block-type memory device, by which program the limitations and drawbacks associated with the prior art can be eliminated or alleviated.

In the present invention, it has surprisingly been found out that by placing the metadata associated with the sequential file in that memory block of the block-type memory device that contains an ending location of the payload data, the write operation associated with updating said sequential file needs in nearly all situations to be directed only to one memory block of the memory device, said memory block being the one containing the ending location of the payload data. The update is carried out so that the new payload data is added in succession to the ending location of the payload data preceding the update, and the new metadata is added in succession after the added payload data.

The write operation must be directed to two memory blocks only in those rare occasions where the payload data to be added would not—in the situation preceding the update—fit in the available free space of the memory block containing the ending location of the payload data. In the above description it is assumed that the quantity of the metadata in bytes is not changed in connection with the update. Let us assume, for the sake of example, that the size of the memory block is four kilobytes, and the payload data to be added is in average 100 bytes. Now the probability for a situation where the write operation should be directed to two memory blocks is roughly 2.5%.

The following advantages are achieved by means of the invention:
the working life of a block-type memory device is extended, because the number of write operations directed to the memory blocks is practically cut to the half in comparison with the prior art arrangement,
the wearing of the writer head used in connection with the magnetic disc memory is slower than in the prior art arrangement, because the number of the writer head transfers is practically cut to the half in comparison with the prior art arrangement, and
the number of the available memory blocks in a flash-type memory device is higher than in the arrangement of the prior art, because the number of memory blocks that are being emptied or are waiting to be emptied at a given moment of observation is smaller than in the arrangement according to the prior art.

The method according to the invention for processing a sequential file stored in a block-type memory device is characterized in that metadata associated with said sequential file is written in that memory block of said block-type memory device that contains an ending location of payload data contained in said sequential file.

The apparatus according to the invention for processing a sequential file stored in a block-type memory device is characterized in that the apparatus comprises a block-type memory device for storing said sequential file and a processor that is arranged to write metadata associated with said sequential file in that memory block of said block-type memory device that contains ending location of payload data contained in said sequential file.

The computer program according to the invention for processing a sequential file stored in a block-type memory device is characterized in that the computer program is provided with software means for instructing a programmable processor to write metadata associated with said sequential file in that memory block of said block-type memory device that contains ending location of payload data contained in said sequential file.

Various embodiments of the invention are characterized by what is set forth in the dependent claims.

### BRIEF DESCRIPTION OF THE DRAWINGS

The invention is described in more detail below, with reference to preferred embodiments illustrated by way of example and to the appended drawings, where

FIG. 1 illustrates in an exemplary situation the location of metadata in the memory space of a block-type memory device in connection with a method according to the invention,

FIGS. 2a and 2b illustrate in a diagram in principle the update of a sequential file stored in a block-type memory device in a method according to an embodiment of the invention,

FIGS. 3a and 3b illustrate in a diagram in principle the update of a sequential file stored in a block-type memory device in a method according to an embodiment of the invention,

FIGS. 4a and 4b illustrate in diagrams in principle the update of a sequential file stored in a block-type memory device in methods according to an embodiment of the invention, and

FIG. 5 illustrates an apparatus according to an embodiment of the invention for processing a sequential file.

### DETAILED DESCRIPTION OF EMBODIMENTS OF THE INVENTION

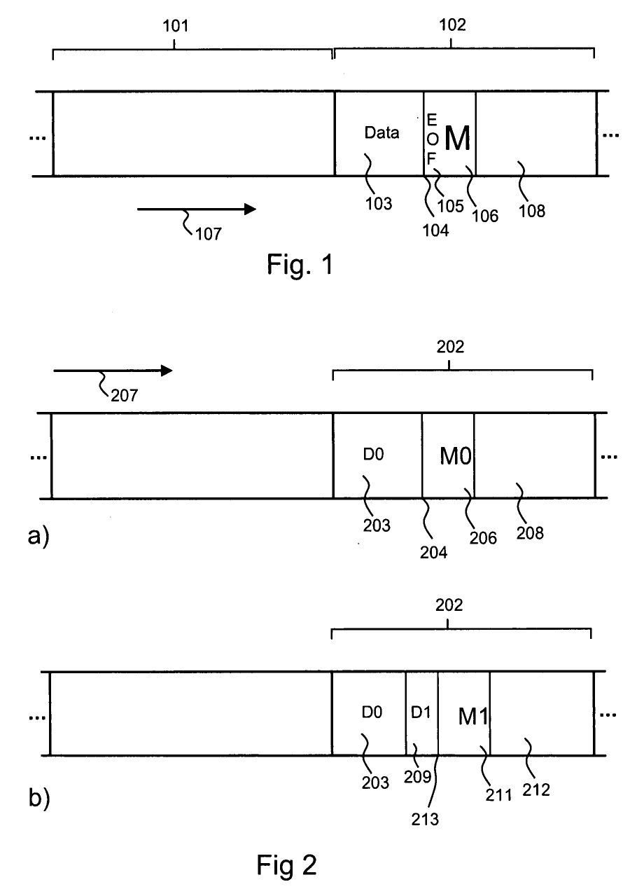

FIG. 1 illustrates in an exemplary situation the location of metadata in the memory space of a block-type memory device in connection with a method according to the invention. The arrow 107 indicates the direction of growth of the memory address. The references 101 and 102 represent memory blocks. The memory block 102 contains the ending location 104 of the payload data (Data) 103 included in said sequential file. The payload data 103 represents only that share of the payload data of the sequential file that is contained in the memory block 102. Also other memory blocks may contain payload data, which is not illustrated in FIG. 1. The ending location 104 is followed by metadata (M) 106. The area of the memory space 108 can be free.

In connection with a method according to an embodiment of the invention, the metadata 106 contains an end of file marker (EOF) 105. Owing to the end of file marker, the ending location of the payload data 104 can be searched without an accurate ending location address data, for instance by a linear search. Said ending location can be found in an updated sequential file, if there is known an address associated with the sequential file, from which the linear search can be started—for instance the address of a respective ending location in the original sequential file, or the address of the start of file location of the sequential file. A linear ending location search can be carried out for example when the apparatus is turned on, whereafter the found ending location address can be stored for instance in the working or temporary memory of the processor. In that case the new ending location address that was changed in the update need not be stored for instance in the block-type memory device under observation, so that said changed ending location address should be directly readable when starting the apparatus.

FIGS. 2a and 2b illustrate, as a diagram in principle, the updating of a sequential file stored in a block-type memory device in a method according to an embodiment of the invention. FIG. 2a illustrates the situation before the update. The arrow 207 indicates the direction of growth of the memory address. The memory block 202 contains the ending location 204 of the payload data (D0) 203 in said sequential file. The ending location 204 is followed by metadata (M0) 206 corresponding to the situation prior to the update. The area of memory space 208 can be free.

FIG. 2b illustrates the situation after the update. The sequential file is updated by writing in the memory block 202 the payload data (D1) 209 to be added in the sequential file in succession to the preceding payload data 203, and the metadata (M1) 211 associated with the updated sequential file in succession to the added payload data 209. The area of memory space 212 can be free. In the situation illustrated by FIG. 2b, the ending of the payload data is in location 213.

In case the free area of the memory space 208 is not sufficient for the payload data 209 to be added, at least one more memory block must be reserved for saving the updated sequential file.

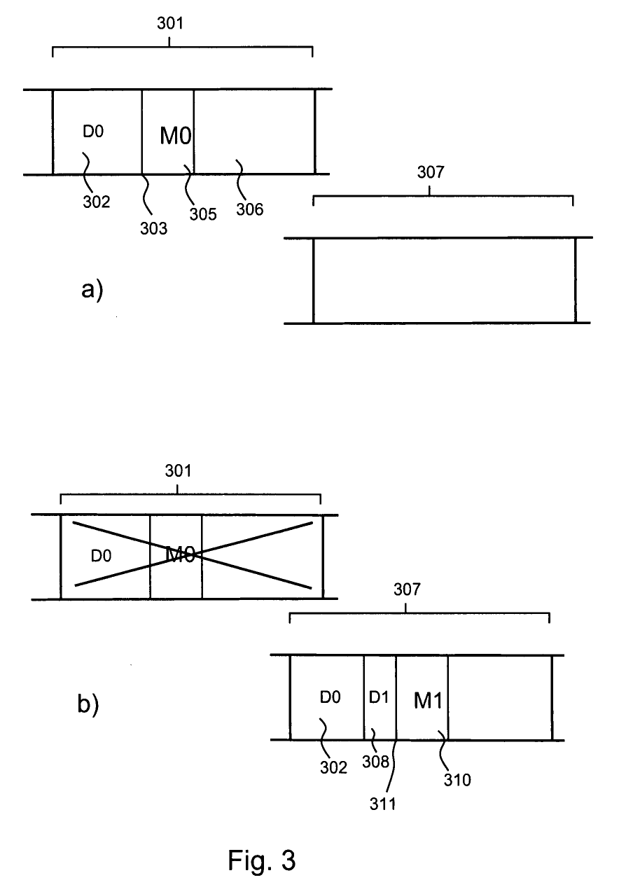

FIGS. 3a and 3b illustrate in a diagram in principle the updating of a sequential file stored in a block-type memory device in a method according to an embodiment of the invention. The embodiment illustrated in FIGS. 3a and 3b is particularly suitable for a flash-type microcircuit memory, where a single byte of a given memory block can be written and read irrespective of other bytes contained in said memory block. When a byte or bit is set, it cannot be changed until the whole memory block is emptied. The emptying of a memory block is a remarkably slower operation than the reading of data from the memory block. In this embodiment, the resulting speed problem is solved so that the changed data is written in another, already emptied memory block, in which case the earlier used memory block only needs to be emptied after the file update and/or as a background operation of the file update.

FIG. 3a illustrates the situation prior to the update. The memory block 301 contains the ending location 303 of the payload data (D0) 302 of said sequential file. The ending location 303 is followed by the metadata (M0) 305 corresponding to the situation before the update. The area of memory space 306 can be free. The memory block 307 is an emptied memory block that is located in a different spot of the address space than the memory block 301. The memory blocks 301 and 307 can be located adjacently or at a distance, so that in between the memory blocks 301 and 307, there are one or several memory blocks.

FIG. 3b illustrates the situation after the update. The sequential file is updated by writing in the memory block 307:
the payload data 302 (D0) contained in the memory block 301;
the payload data (D1) 308 to be added in the sequential file, after the payload data 302, and
the metadata (M1) 310 associated with the updated sequential file in succession to the added ending location of the payload data 311.

The memory block 301 is commanded to be emptied. Advantageously the emptying is carried out as a background operation, apart from the above described update operation.

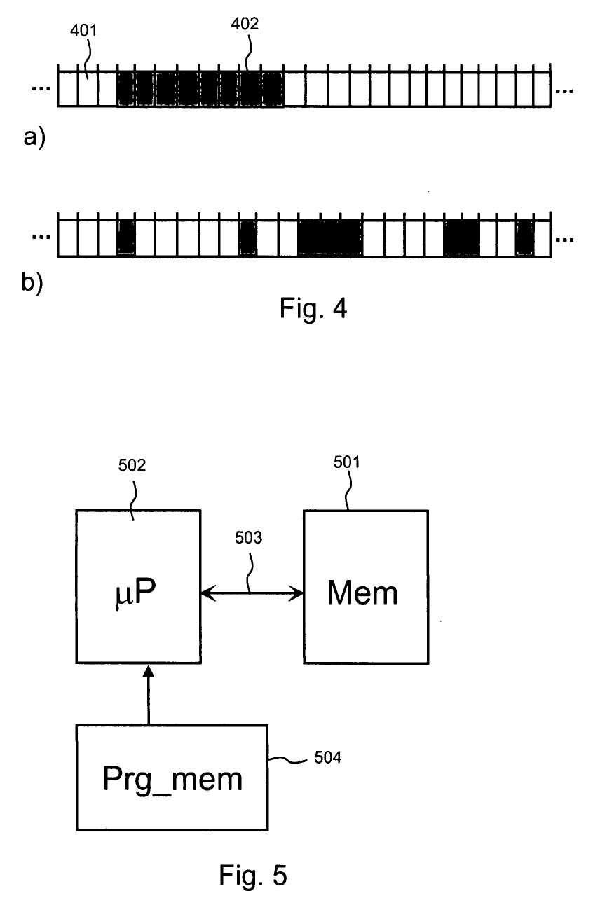

FIGS. 4a and 4b illustrate as diagrams in principle the saving of a sequential file stored in a block-type memory device in methods according to embodiments of the invention. In the situation illustrated in FIG. 4a, the memory blocks containing said sequential file are located in succession in the address space of the block-type memory device. One square represents a memory block, for example the square referred to by number 401. The darkened area 402 represents those memory blocks that contain said sequential file. In the situation illustrated in FIG. 4b, the memory blocks containing said sequential file, which are illustrated as darkened in FIG. 4b, are distributed in the address space of the block-type memory device. FIGS. 4a and 4b illustrate the location in principle of only one sequential file in the memory space of the block-type memory. In practical systems, one block-type memory device contains several stored sequential files.

In an embodiment of the invention, individual files can be reached by means of a hierarchical index structure. A root level index contains a list of the next level indexes and the logical addresses where each index can be found. If a name included in the index does not represent an index, said name represents a file, and the connected logical address refers to the metadata of said file. If metadata is in the update process transferred to a different memory block, also the logical address referring to said metadata is updated in the working memory of the system.

FIG. 5 illustrates an apparatus according to an embodiment of the invention for processing a sequential file. The apparatus includes a block-type memory device 501 for saving said sequential file and a processor 502 that is arranged to write the metadata associated with said sequential file in that memory block of said block-type memory device that contains the ending location of the payload data of said sequential file. In between the processor 502 and the memory device, there is arranged a bus 503 through which the processor and the memory device communicate.

In an apparatus according to an embodiment of the invention, said block-type memory device 501 is a flash-type microcircuit memory.

In an apparatus according to an embodiment of the invention, said block-type memory device 501 is a magnetic disc.

In an apparatus according to an embodiment of the invention, said processor 502 is arranged to update said sequential file by writing the payload data to be added in the sequential file and the metadata associated with the sequential file in that memory block of said block-type memory device that contains the ending location of the payload data of said sequential file.

In an apparatus according to an embodiment of the invention, said processor 502 is arranged to update said sequential file by commanding that memory block in said memory device that contains the ending location of the payload data of said sequential file prior to the update to be emptied, and by writing the payload data contained in said memory block, the payload data to be added in the sequential file and the metadata associated with the updated sequential file in another memory block of said block-type memory device.

In an apparatus according to an embodiment of the invention, said processor 502 is arranged to select those memory blocks that contain said sequential file to be located in succession in the address space of said block-type memory device.

In an apparatus according to an embodiment of the invention, said processor 502 is arranged to select those memory blocks that contain said sequential file, to be distributed in the address space of said block-type memory device.

In an apparatus according to an embodiment of the invention, said processor 502 is a programmable processor and the apparatus is provided with a memory device 504 for storing a computer program that controls the processor. In an apparatus according to an alternative embodiment of the invention, said processor 502 has an inner memory for storing the computer program controlling the processor. In an apparatus according to another alternative embodiment of the invention, said processor 502 is a device based on one or several ASIC circuits (Application Specific Integrated Circuits) and/or FPGA components (Field Programmable Gate Array), and the operational control of the device is based on connections between logical gates, in which case a computer program is not needed.

A computer program according to an embodiment of the invention includes software means, such as subroutines and functions, for controlling the processor 502 in order to write the metadata associated with the sequential file in that memory block of the block-type memory device that contains the ending location of the payload data contained in the sequential file.

For a man skilled in the art, the invention and its various embodiments are obviously not restricted to the above described exemplary embodiments, but the invention and its embodiments can be varied within the scope of the independent claim.

1. A method for processing a sequential file stored in a block-type memory device, wherein metadata associated with said sequential file is written in a memory block of said block-type memory device, which memory block contains an ending location of payload data contained in said sequential file.

2. A method according to claim 1, wherein said sequential file is updated by writing both the payload data to be added in the sequential file and the metadata associated with the updated sequential file in a memory block of said block-type memory device, said memory block containing the ending location of the payload data contained in the sequential file prior to the update.

3. A method according to claim 1, wherein said sequential file is updated by commanding that memory block of said memory device that contains the ending location of the payload data contained in said sequential file prior to the update, to be emptied and by writing the payload data contained in said memory block, the payload data to be added in the sequential file, and the metadata associated with the updated sequential file in another memory block of said block-type memory device.

4. A method according to claim 1, wherein those memory blocks that contain said sequential file are located in succession in an address space of said block-type memory device.

5. A method according to claim 1, wherein those memory blocks that contain said sequential file are located in a distributed manner in an address space of said block-type memory device.

6. An apparatus for processing a sequential file, the apparatus comprising:
a block-type memory device for storing said sequential file, and
a processor that is arranged to write metadata associated with said sequential file in a memory block of the block-type memory device, which memory block contains an ending location of payload data contained in said sequential file.

7. An apparatus according to claim 6, wherein said block-type memory device is a flash-type microcircuit memory.

8. An apparatus according to claim 6, wherein said block-type memory device is a magnetic disc.

9. An apparatus according to claim 6, wherein said processor is arranged to update said sequential file by writing the payload data to be added in the sequential file and the metadata associated with the updated sequential file in a memory block of a block-type memory device, said memory block containing the ending location of the payload data contained in the sequential file prior to the update.

10. An apparatus according to claim 6, wherein said processor is arranged to update said sequential file by commanding that memory block of the memory device that contains the ending location of the payload data contained in said sequential file prior to the update to be emptied, and by writing the payload data contained in said memory block, the payload data to be added in the sequential file, and the metadata associated with the updated sequential file in another memory block of said block-type memory device.

11. An apparatus according to claim 6, wherein said processor is arranged to select those memory blocks that contain said sequential file to be located in succession in an address space of said block-type memory space.

12. An apparatus according to claim 6, wherein said processor is arranged to select those memory blocks that contain said sequential file to be located in a distributed manner in an address space of said block-type memory device.

13. An apparatus according to claim 6, wherein said processor is a programmable processor and the apparatus includes a memory device for storing a computer program for controlling the processor.

14. A computer program for processing a sequential file stored in a block-type memory device, wherein the computer program comprises software means for instructing a programmable processor to write metadata associated with said sequential file in a memory block of said block-type memory device, which memory block contains an ending location of the payload data contained in said sequential file.
